(19) United States
(12) Patent Application Publication
(10) Pub. No.: US 2024/0372685 A1
(43) Pub. Date: Nov. 7, 2024

(54) Transmission Methods For Hybrid Power Modes In 6GHz Frequency Band

(71) Applicant: MediaTek Inc., Hsinchu City (TW)

(72) Inventors: Shengquan Hu, San Jose, CA (US); Jianhan Liu, San Jose, CA (US); Thomas Edward Pare, JR., San Jose, CA (US)

(21) Appl. No.: 18/655,236

(22) Filed: May 4, 2024

Related U.S. Application Data
(60) Provisional application No. 63/500,297, filed on May 5, 2023.

(51) Int. Cl. H04L 5/00

(52) U.S. Cl. CPC H04L 5/0092

(57) ABSTRACT

Techniques pertaining to transmission methods for hybrid power modes in 6 GHz frequency band in wireless communications are described. An apparatus (e.g., station (STA)) generates one or more resource unit (RUs). The apparatus then communicates wirelessly using the one or more RUs with a hybrid of power modes.

### CROSS REFERENCE TO RELATED PATENT APPLICATION(S)

The present disclosure is part of a non-provisional patent application claiming the priority benefit of U.S. Provisional Patent Application No. 63/500,297, filed 5 May 2023, the content of which herein being incorporated by reference in its entirety.

### TECHNICAL FIELD

The present disclosure is generally related to wireless communications and, more particularly, to transmission methods for hybrid power modes in 6 GHz frequency band in wireless communications.

### BACKGROUND

Unless otherwise indicated herein, approaches described in this section are not prior art to the claims listed below and are not admitted as prior art by inclusion in this section.

In wireless communications such as Wi-Fi (or WiFi) in accordance with the Institute of Electrical and Electronics Engineers (IEEE) 802.11 standards, three are three power modes in the 6 GHz frequency band, namely: Standard Power (SP), Low Power Indoor (LPI) and Very Low Power (VLP). With the Automated Frequency Coordination (AFC) services, an access point (AP) and a station (STA) may transmit at a higher power in some channels of the 6 GHz frequency band. However, at least three 160 MHz bandwidth channels are only available for LPI. For some wider bandwidth 320 MHz, part of the 320 MHz spectrum is also for LPI only. As such, in order to more efficiently utilize the 6 GHz spectrum, there needs to be new transmission methods for hybrid power modes in the 6 GHz frequency band. Therefore, there is a need for a solution of transmission methods for hybrid power modes in 6 GHz frequency band in wireless communications.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to provide schemes, concepts, designs, techniques, methods and apparatuses pertaining to transmission methods for hybrid power modes in 6 GHz frequency band in wireless communications. Under various proposed schemes in accordance with the present disclosure, mixed-distribution bandwidth operations may be enabled with DRU resource assignment and scheduling described herein. Under the proposed schemes, AFC and distributed-tone resource units (DRUs or dRUs) may be treated as complementary technologies to use together in utilizing the 6 GHz spectrum more efficiently. Moreover, under the proposed schemes, unequal quadrature amplitude modulations (QAMs) or unequal modulation and coding schemes (MCSs) may be utilized for hybrid power mode transmissions to improve system throughput. Furthermore, new signaling methods are utilized under the proposed schemes to enable hybrid power mode transmissions and mixed multi-resource unit (MRU), with regular resource unit (RRU or rRU) and DRU transmissions.

In one aspect, a method may involve a processor of an apparatus generating one or more resource unit (RUs). The method may also involve the processor communicating wirelessly using the one or more RUs with a hybrid of power modes.

In another aspect, an apparatus may include a transceiver configured to communicate wirelessly and a processor coupled to the transceiver. The processor may generate one or more RUs. The processor may communicate wirelessly using the one or more RUs with a hybrid of power modes.

It is noteworthy that, although description provided herein may be in the context of certain radio access technologies, networks and network topologies such as, Wi-Fi/WLAN, the proposed concepts, schemes and any variation(s)/derivative(s) thereof may be implemented in, for and by other types of radio access technologies, networks and network topologies such as, for example and without limitation, Bluetooth, ZigBee, 5th Generation (5G)/New Radio (NR), Long-Term Evolution (LTE), LTE-Advanced, LTE-Advanced Pro, Internet-of-Things (IoT), Industrial IoT (IIoT) and narrowband IoT (NB-IoT). Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation to clearly illustrate the concept of the present disclosure.

FIG. 1 is a diagram of an example network environment in which various solutions and schemes in accordance with the present disclosure may be implemented.

FIG. 2 is a diagram of an example scenario under a proposed scheme in accordance with the present disclosure.

FIG. 3 is a diagram of an example scenario under a proposed scheme in accordance with the present disclosure.

FIG. 4 is a diagram of an example scenario under a proposed scheme in accordance with the present disclosure.

FIG. 5 is a diagram of an example scenario under a proposed scheme in accordance with the present disclosure.

FIG. 6 is a diagram of an example scenario under a proposed scheme in accordance with the present disclosure.

FIG. 7 is a diagram of an example scenario under a proposed scheme in accordance with the present disclosure.

FIG. 8 is a diagram of an example scenario under a proposed scheme in accordance with the present disclosure.

FIG. 9 is a diagram of an example scenario under a proposed scheme in accordance with the present disclosure.

FIG. 10 is a block diagram of an example communication system in accordance with an implementation of the present disclosure.

FIG. 11 is a flowchart of an example process in accordance with an implementation of the present disclosure.

### DETAILED DESCRIPTION OF PREFERRED EMBODIMENTS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to transmission methods for hybrid power modes in 6 GHz frequency band in wireless communications. According to the present disclosure, a number of possible solutions may be implemented separately or jointly. That is, although these possible solutions may be described below separately, two or more of these possible solutions may be implemented in one combination or another.

It is noteworthy that, in the present disclosure, a regular (non-distributed) RU (RRU) refers to a RU with tones that are continuous (e.g., adjacent to one another) and not interleaved, interlaced or otherwise distributed. Moreover, a 26-tone regular RU may be interchangeably denoted as RU26 (or RRU26), a 52-tone regular RU may be interchangeably denoted as RU52 (or RRU52), a 106-tone regular RU may be interchangeably denoted as RU106 (or RRU106), a 242-tone regular RU may be interchangeably denoted as RU242 (or RRU242), and so on. Moreover, a 26-tone distributed-tone RU may be interchangeably denoted as DRU26 (or iRU26, or dRU26), a 52-tone distributed-tone RU may be interchangeably denoted as DRU52 (or iRU52, or dRU52), a 106-tone distributed-tone RU may be interchangeably denoted as DRU106 (or iRU106, or dRU106), a 242-tone distributed-tone RU may be interchangeably denoted as DRU242 (or iRU242, or dRU242), and so on. Moreover, an aggregate (26+52)-tone regular multi-RU (MRU) may be interchangeably denoted as MRU78 (or rMRU78, or RMRU78), an aggregate (26+106)-tone regular MRU may be interchangeably denoted as MRU132 (or rMRU132, or RMRU132), and so on. Furthermore, an aggregate (26+52)-tone distributed-tone MRU (DMRU or dMRU) may be interchangeably denoted as DMRU132 (or dMRU132), and so on.

It is also noteworthy that, in the present disclosure, a bandwidth of 20 MHz may be interchangeably denoted as BW20 or BW20M, a bandwidth of 40 MHz may be interchangeably denoted as BW40 or BW40M, a bandwidth of 80 MHz may be interchangeably denoted as BW80 or BW80M, a bandwidth of 160 MHz may be interchangeably denoted as BW160 or BW160M, a bandwidth of 240 MHz may be interchangeably denoted as BW240 or BW240M, a bandwidth of 320 MHz may be interchangeably denoted as BW320 or BW320M, a bandwidth of 480 MHz may be interchangeably denoted as BW480 or BW480M, a bandwidth of 500 MHz may be interchangeably denoted as BW500 or BW500M, a bandwidth of 520 MHz may be interchangeably denoted as BW520 or BW520M, a bandwidth of 540 MHz may be interchangeably denoted as BW540 or BW540M, a bandwidth of 640 MHz may be interchangeably denoted as BW640 or BW640M.

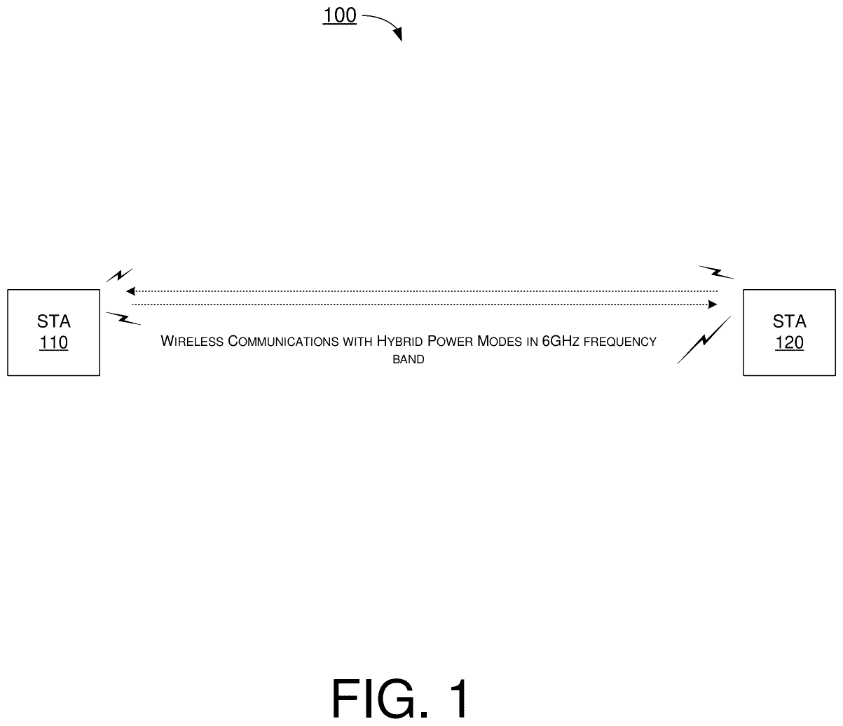

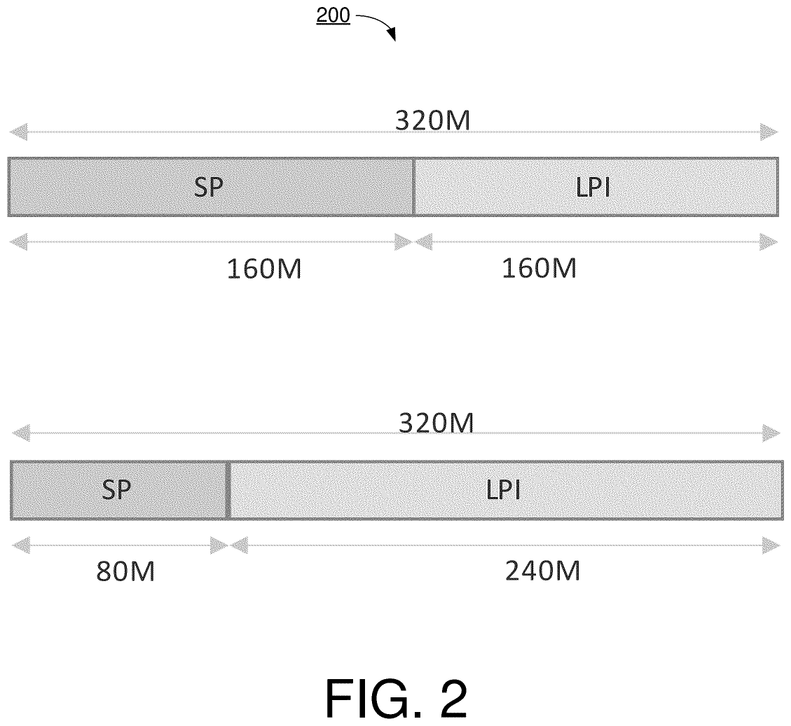

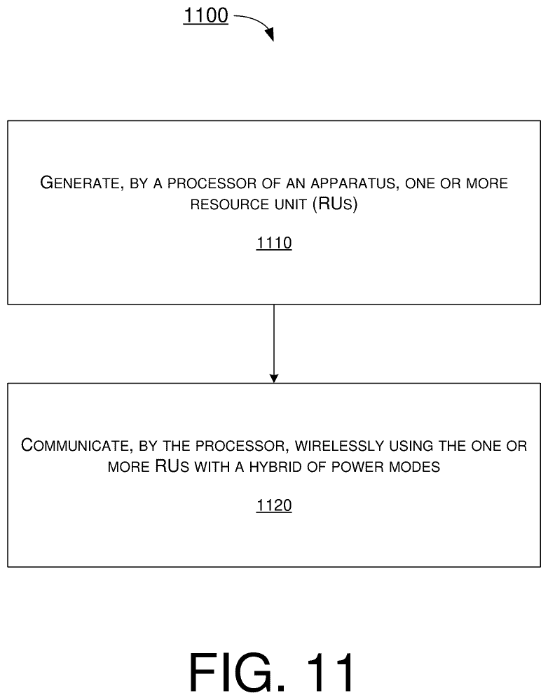

FIG. 1 illustrates an example network environment 100 in which various solutions and schemes in accordance with the present disclosure may be implemented. FIG. 2˜FIG. 11 illustrate examples of implementation of various proposed schemes in network environment 100 in accordance with the present disclosure. The following description of various proposed schemes is provided with reference to FIG. 1˜FIG. 11.

Referring to FIG. 1, network environment 100 may involve at least a STA 110 communicating wirelessly with a STA 120. Either of STA 110 and STA 120 may be an access point (AP) STA or, alternatively, either of STA 110 and STA 120 may function as a non-AP STA. In some cases, STA 110 and STA 120 may be associated with a basic service set (BSS) in accordance with one or more IEEE 802.11 standards (e.g., IEEE 802.11be and future-developed standards). Each of STA 110 and STA 120 may be configured to communicate with each other by utilizing the various proposed schemes of transmission methods for hybrid power modes in 6 GHz frequency band in wireless communications in accordance with various proposed schemes described below. That is, either or both of STA 110 and STA 120 may function as a “user” in the proposed schemes and examples described below. It is noteworthy that, while the various proposed schemes may be individually or separately described below, in actual implementations some or all of the proposed schemes may be utilized or otherwise implemented jointly. Of course, each of the proposed schemes may be utilized or otherwise implemented individually or separately.

At the time of the present invention, 1200 MHz of spectrum in the 6 GHz frequency band is available in the United States (US), although only three 160 MHz frequency segments are for LPI, which is about 43% of the total 6 GHz available spectrum. Also, about 480 MHz spectrum of the 6 GHz frequency band in the European Union (EU) is allocated for LPI and VLP only. To utilize the entire 6 GHz spectrum more efficiently, DRU may be utilized under various schemes proposed herein as an important feature in Ultra-High Reliability (UHR) Wi-Fi communications to boost transmission power. For instance, DRUs may be utilized on BW160 to boost transmission power, and the transmission power may still be lower than the maximum allowed power. In terms of 6 GHZ channelization, 80 MHz, 160 MHz and 320 MHz channelization in the 6 GHz frequency band is defined in the IEEE 802.11be specification. Potentially, a wider bandwidth (e.g., 480 MHz or 640 MHz) may be supported in UHR for next-generation Wi-Fi such as Wi-Fi 8 and beyond. It is noteworthy that, at the present time, there is discussion on opening up the 6 GHz frequency band to 7.25 GHz. With respect to AFC and LPI channel mapping in the 6 GHz frequency band, certain spectrums may be suitable for SP (AFC) only or a hybrid of SP (AFC) and LPI, certain spectrums may be suitable for AFC (160 MHz)+LPI (160 MHz) (which may be a hybrid of SP (AFC) and LPI), while certain other spectrums may be suitable for LPI only.

FIG. 2 illustrates an example scenario 200 under a proposed scheme in accordance with the present disclosure. Scenario 200 may pertain to a hybrid power mode transmission under a first option (Option-1). Under the proposed scheme, within a transmission bandwidth, one portion of a given spectrum may be utilized with SP (under AFC) transmission while another portion of the spectrum may be utilized with LPI transmission. For instance, a STA (e.g., STA 110) may be scheduled to operate with only one power mode (e.g., SP or LPI). Referring to FIG. 2, transmission in a first 160 MHz of a 320 MHz bandwidth may be in the SP mode while transmission in a second 160 MHz of the 320 MHz bandwidth may be in the LPI mode. Alternatively, transmission in an 80 MHz spectrum of a 320 MHz bandwidth may be in the SP mode while transmission in the remaining 240 MHz spectrum of the 320 MHz bandwidth may be in the LPI mode. Under the proposed scheme, when an AP (e.g., STA 120) transmits with a hybrid power mode (e.g., SP and LPI modes), a downlink (DL) trigger frame may be transmitted on the SP (or AFC) portion to achieve a better range coverage.

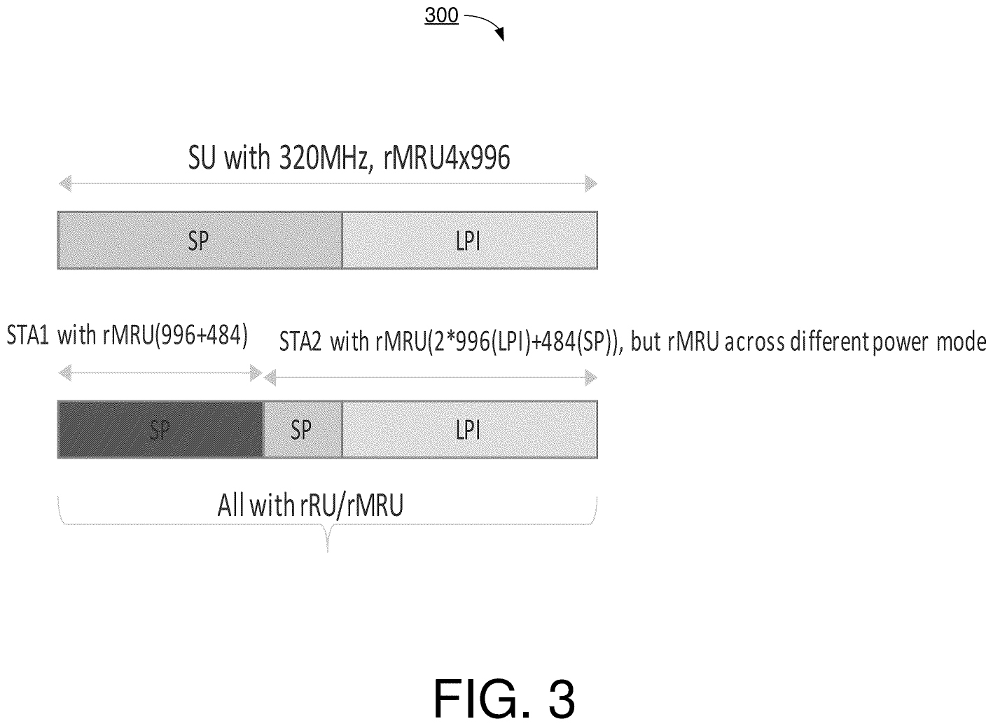

FIG. 3 illustrates an example scenario 300 under a proposed scheme in accordance with the present disclosure. Scenario 300 may pertain to a hybrid power mode transmission under a second option (Option-2). Under the proposed scheme, one user (e.g., a STA such as STA 110) may be scheduled with resource(s) across AFC and LPI regions (e.g., the assigned resource(s) may span over an SP (or AFC) portion and an LPI portion). Under the proposed scheme, RRUs or regular multi-resource units (RMRUs or rMRUs) may be used in both the SP and LPI regions. Referring to FIG. 3, for a single-user (SU) transmission with a 320 MHz bandwidth and RMRU (4×996), one portion of the transmission may be in the SP mode while another portion of the transmission may be in the LPI mode. When there are two users (e.g., STA1 and STA2, as shown in FIG. 3), STA1 may transmit a RMRU (996+484) in the SP mode in the SP region. On the other hand, STA2 may transmit a RMRU (2×996+484) across different power mode regions, such as transmission of RU (484) in the SP mode in the SP region and transmission of MRU (2×996) in the LPI mode in the LPI region.

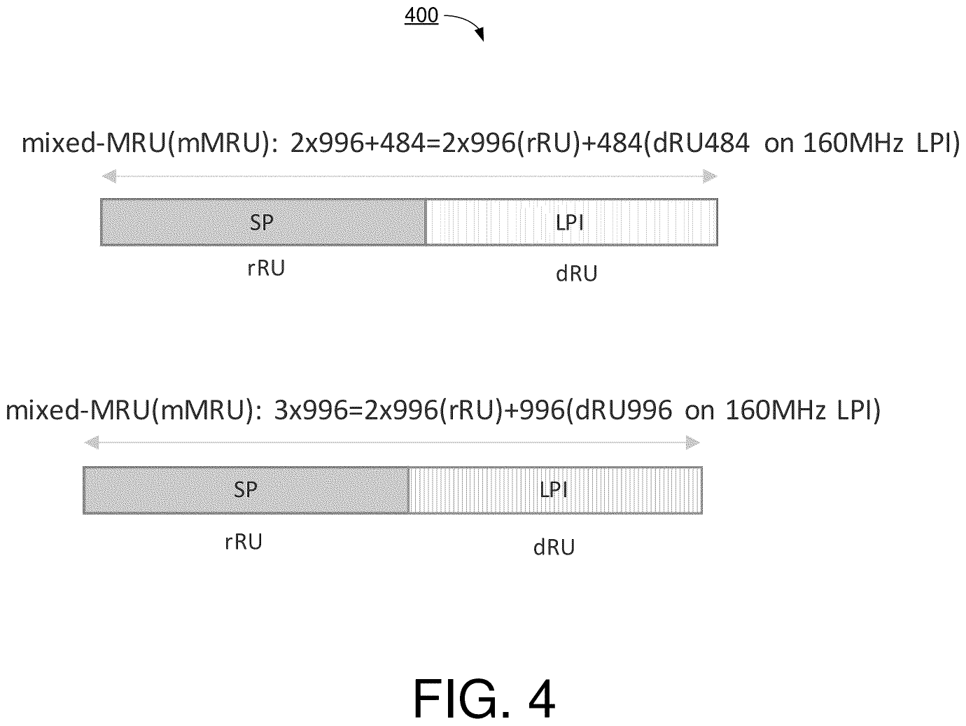

FIG. 4 illustrates an example scenario 400 under a proposed scheme in accordance with the present disclosure. Scenario 400 may pertain to a hybrid power mode transmission under a third option (Option-3). Under the proposed scheme, to take advantage of power boost gain by using DRUs, mixed-RU type transmission may be utilized when the spectrum is across regions of different power modes. For instance, one user (e.g., a STA such as STA 110) may be scheduled with different RU types (e.g., RRU and DRU) on different power mode regions. Referring to FIG. 4, STA 110 may be scheduled with a mixed-MRU (MMRU or mMRU) of 2×996+484=2×996-tone RRU+484-tone DRU, such that the RRU may be transmitted in the SP mode in the SP region and the DRU may be transmitted in the LPI mode in the LPI region. As another example, STA 110 may be scheduled with a MMRU of 3×996+484=2×996-tone RRU+996-tone DRU, such that the RRU may be transmitted in the SP mode in the SP region and the DRU may be transmitted in the LPI mode in the LPI region.

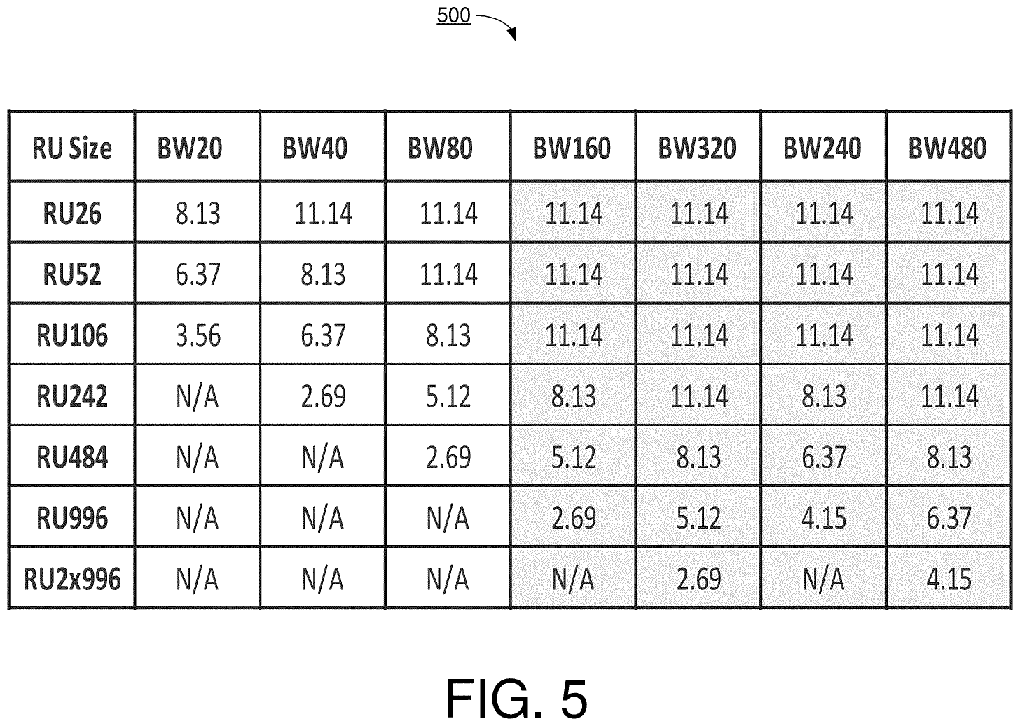

FIG. 5 illustrates an example scenario 500 under a proposed scheme in accordance with the present disclosure. Scenario 500 may pertain to a hybrid power mode transmission under Option-3. For hybrid power mode transmission under Option-3, the power boost gain may be considered in scaling. For instance, it may be assumed that Option-3 is utilized only for uplink (UL) trigger-based (TB) physical-layer protocol data unit (PPDU) transmissions. The power spectral density (PSD) gap between SP and LPI may be 18 dB. The power boost gain may depend on DRU size and distribution bandwidth. The table in FIG. 5 shows a summary of power boost gains (in dB) for different DRU sizes on different distribution bandwidths. Under the proposed scheme, signals of an LPI portion (with DRU transmission) may be scaled.

With respect to signaling to enable hybrid power mode transmissions, it may be assumed that an AP (e.g., STA 120) will update AFC channel status periodically in Beacon frames or other management frames. Then, its associated STAs (including STA 110) may know which channel is available for transmission in the SP mode. Given that DL (or SU) hybrid power mode transmission is transparent to STAs, no signaling may be necessary. The AP may perform the power scaling accordingly for the different power mode resource regions or AFC availability. It may be assumed that DRU is not used for DL transmissions under the proposed schemes. For UL TB PPDU transmissions with hybrid power modes, a STA (e.g., STA 110) may need to know the following information: (1) which channel is AFC available, (2) in LPI channel, what RU type is scheduled (e.g., RRU or DRU), and (3) whether a bitmap method can be used for MMRU signaling.

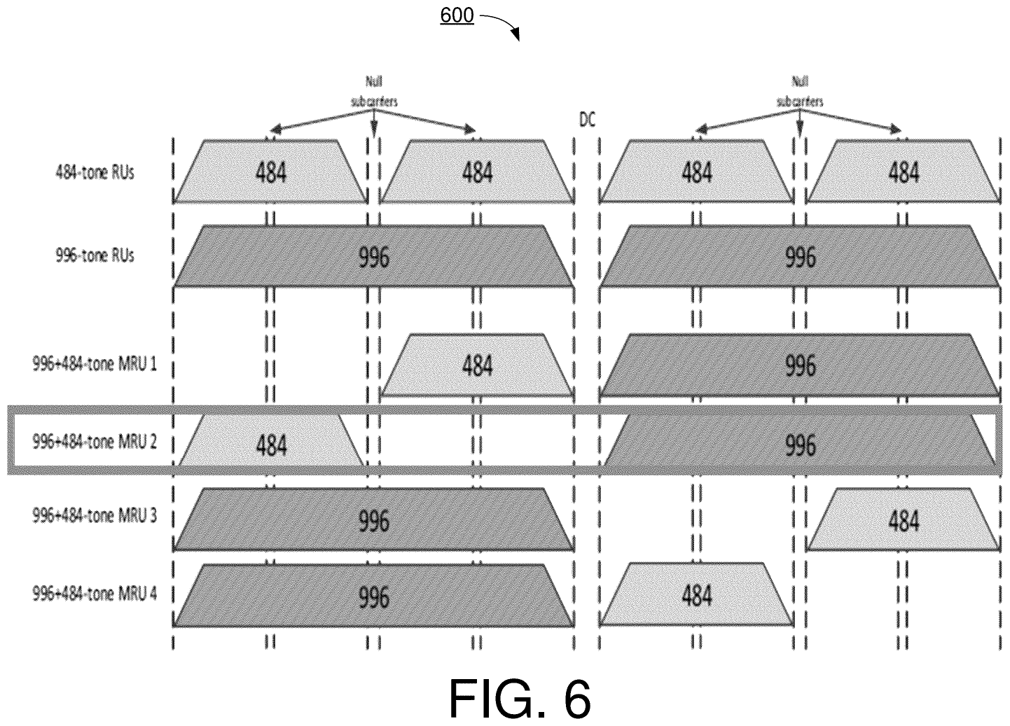

FIG. 6 illustrates an example scenario 600 under a proposed scheme in accordance with the present disclosure. Scenario 600 may pertain to MMRU signaling for a hybrid power transmission. Under the proposed scheme, a bitmap value of “1” per 80 MHz frequency segment or subblock may be used to indicate the RU type in a corresponding 80 MHz frequency segment or subblock. For a large-size MRU such as 996+484-tone MRU, 2×996+484-tone MRU, 3×996+484-tone MRU, 2×996-tone MRU, 3×996-tone MRU, and the like, the bitmap may be utilized to indicate which part of the MRU is on the LPI region and that DRU is used. Moreover, an MRU index may be utilized to indicate the MRU combination option and may also indicate which RU size is in which 80 MHz frequency segment or subblock. Referring to FIG. 6, in the example shown, BW=160 MHz for a 996+484-tone MRU2. In case that the bitmap=“00”, MRU2 may be a RMRU. In that case that the bitmap=“10”, MRU2 may be an MMRU. In the latter case, “484” in FIG. 6 may denote a DRU484 transmitted on a lower 80 MHz and “996” in FIG. 6 may denote a RRU996 transmitted on an upper 80 MHz.

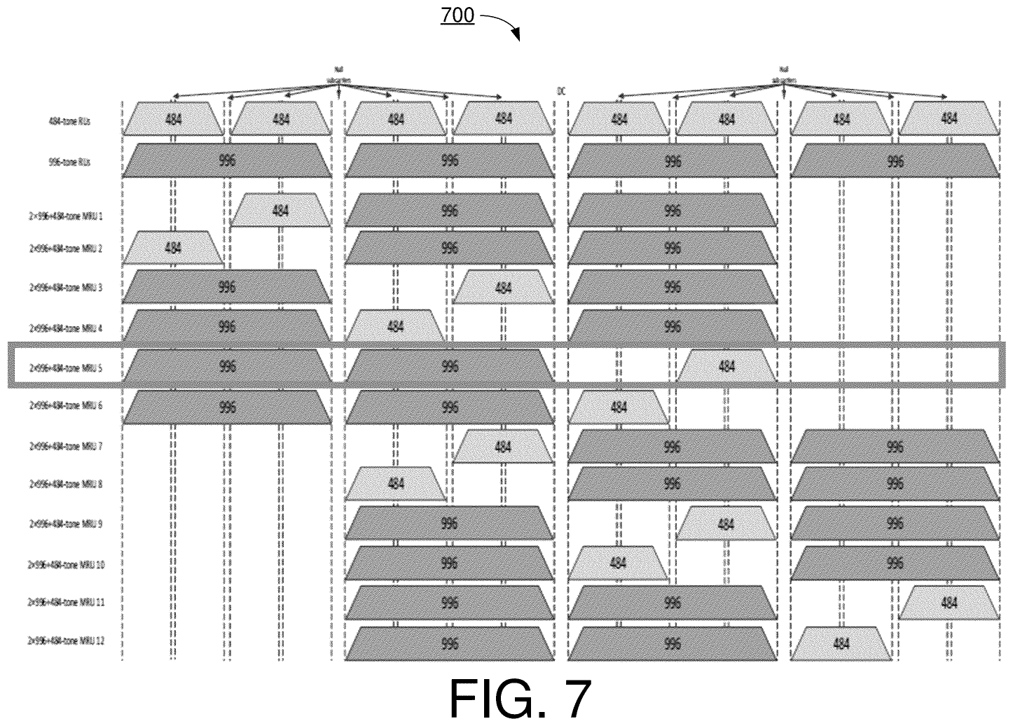

FIG. 7 illustrates an example scenario 700 under a proposed scheme in accordance with the present disclosure. Scenario 700 may pertain to MMRU signaling for a hybrid power transmission. Referring to FIG. 7, in the example shown, BW=320 MHz for a 2×996+484-tone MRU5. In case that the bitmap=“0000”, MRU5 may be a RMRU. In case that the bitmap=“0010”, MRU2 may be a MMRU. In such a case, “484” in FIG. 7 may denote a DRU484 transmitted on a 3^{rd} 80 MHz and “2×996” in FIG. 7 may denote an RRU (2×996) transmitted on a lower 160 MHz. In case that the bitmap=“0011”, MRU2 may be a MMRU. In such a case, “484” in FIG. 7 may denote a DRU484 transmitted on an upper 160 MHz and “2×996” may denote an RRU (2×996) transmitted on a lower 160 MHz.

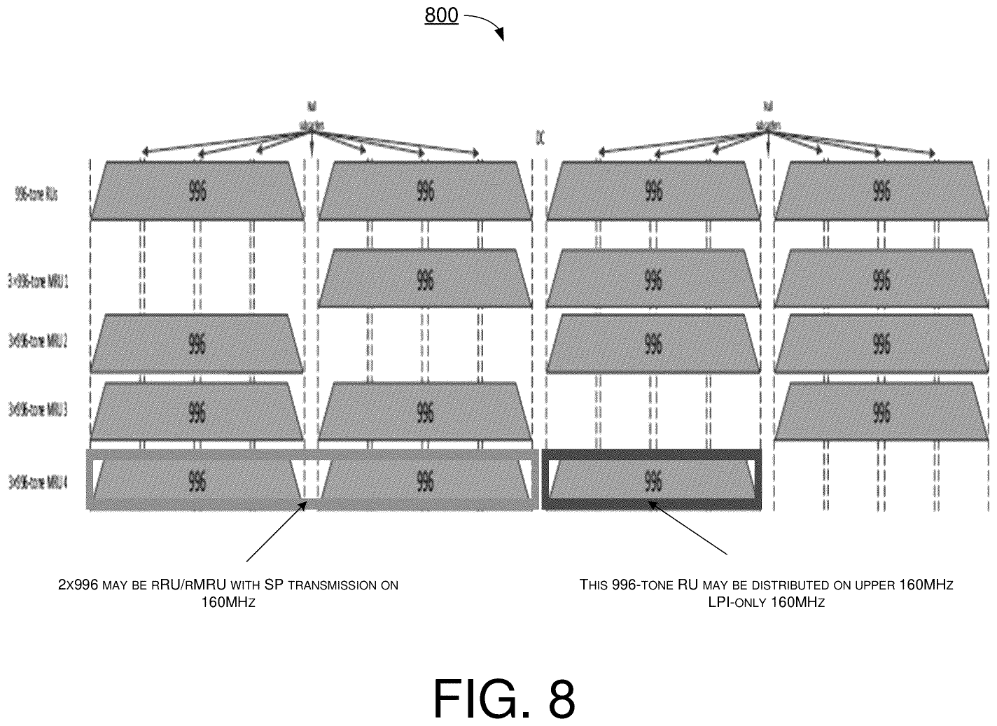

FIG. 8 illustrates an example scenario 800 under a proposed scheme in accordance with the present disclosure. Scenario 800 may pertain to MMRU signaling for a hybrid power transmission. Referring to FIG. 8, “2×996” in FIG. 8 may denote a RRU or RMRU transmitted in the SP mode on a lower 160 MHz and “996” may denote a DRU transmitted in the LPI mode on an upper 160 MHz.

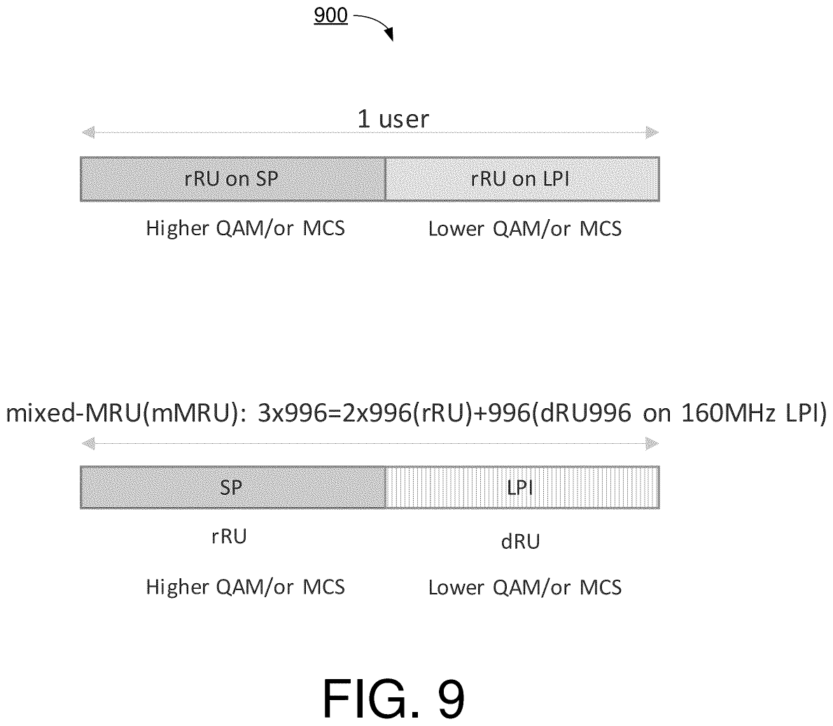

FIG. 9 illustrates an example scenario 900 under a proposed scheme in accordance with the present disclosure. Scenario 900 may pertain to a hybrid power mode transmission with unequal QAMs or unequal MCSs under a fourth option (Option-4). Under the proposed scheme, the difference of a maximum equivalent isotropic radiated power (EIRP) transmission power between SP and LPI modes may be up to 24 dB. Accordingly, under the proposed scheme, unequal QAMs or unequal MCSs may be utilized in transmission so as to improve system throughput. For instance, a higher QAM or higher MCS may be assigned on the resource transmitted with SP (or AFC available) on an SP portion, and a lower QAM or lower MCS may be assigned on another resource transmitted with LPI mode on an LPI portion. Referring to FIG. 9, for a single user (e.g., a STA such as STA 110), an RRU may be modulated with a higher QAM or MCS and transmitted in the SP region in SP mode, and another RRU may be modulated with a lower QAM or MCS and transmitted in the LPI region in LPI mode. As another example, with MMRU of 3×996=2×996-tone RRU+996-tone DRU, the 2×996-tone RRU may be transmitted with a higher QAM or MCS and transmitted in the SP region in SP mode, and the 996-tone DRU may be modulated with a lower QAM or MCS and transmitted in the LPI region in LPI mode.

### Illustrative Implementations

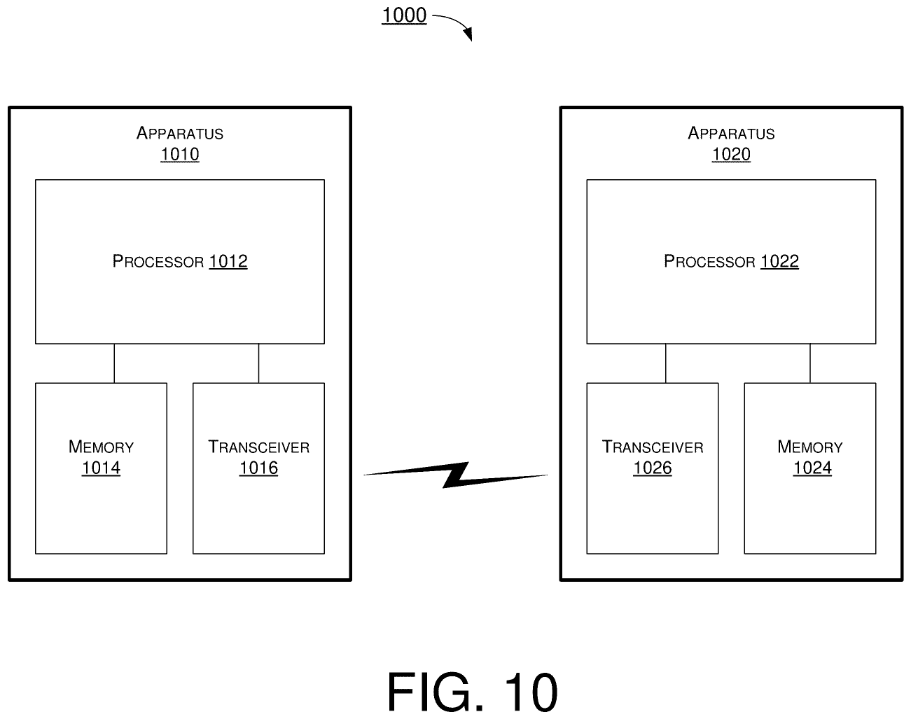

FIG. 10 illustrates an example system 1000 having at least an example apparatus 1010 and an example apparatus 1020 in accordance with an implementation of the present disclosure. Each of apparatus 1010 and apparatus 1020 may perform various functions to implement schemes, techniques, processes and methods described herein pertaining to transmission methods for hybrid power modes in 6 GHz frequency band in wireless communications, including the various schemes described above with respect to various proposed designs, concepts, schemes, systems and methods described above as well as processes described below. For instance, apparatus 1010 may be implemented in STA 110 and apparatus 1020 may be implemented in STA 120, or vice versa.

Each of apparatus 1010 and apparatus 1020 may be a part of an electronic apparatus, which may be a non-AP STA or an AP STA, such as a portable or mobile apparatus, a wearable apparatus, a wireless communication apparatus or a computing apparatus. When implemented in a STA, each of apparatus 1010 and apparatus 1020 may be implemented in a smartphone, a smart watch, a personal digital assistant, a digital camera, or a computing equipment such as a tablet computer, a laptop computer or a notebook computer. Each of apparatus 1010 and apparatus 1020 may also be a part of a machine type apparatus, which may be an IoT apparatus such as an immobile or a stationary apparatus, a home apparatus, a wire communication apparatus or a computing apparatus. For instance, each of apparatus 1010 and apparatus 1020 may be implemented in a smart thermostat, a smart fridge, a smart door lock, a wireless speaker or a home control center. When implemented in or as a network apparatus, apparatus 1010 and/or apparatus 1020 may be implemented in a network node, such as an AP in a WLAN.

In some implementations, each of apparatus 1010 and apparatus 1020 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. In the various schemes described above, each of apparatus 1010 and apparatus 1020 may be implemented in or as a STA or an AP. Each of apparatus 1010 and apparatus 1020 may include at least some of those components shown in FIG. 10 such as a processor 1012 and a processor 1022, respectively, for example. Each of apparatus 1010 and apparatus 1020 may further include one or more other components not pertinent to the proposed scheme of the present disclosure (e.g., internal power supply, display device and/or user interface device), and, thus, such component(s) of apparatus 1010 and apparatus 1020 are neither shown in FIG. 10 nor described below in the interest of simplicity and brevity.

In one aspect, each of processor 1012 and processor 1022 may be implemented in the form of one or more single-core processors, one or more multi-core processors, one or more RISC processors or one or more CISC processors. That is, even though a singular term “a processor” is used herein to refer to processor 1012 and processor 1022, each of processor 1012 and processor 1022 may include multiple processors in some implementations and a single processor in other implementations in accordance with the present disclosure. In another aspect, each of processor 1012 and processor 1022 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 1012 and processor 1022 is a special-purpose machine specifically designed, arranged and configured to perform specific tasks including those pertaining to transmission methods for hybrid power modes in 6 GHz frequency band in wireless communications in accordance with various implementations of the present disclosure.

In some implementations, apparatus 1010 may also include a transceiver 1016 coupled to processor 1012. Transceiver 1016 may include a transmitter capable of wirelessly transmitting and a receiver capable of wirelessly receiving data. In some implementations, apparatus 1020 may also include a transceiver 1026 coupled to processor 1022. Transceiver 1026 may include a transmitter capable of wirelessly transmitting and a receiver capable of wirelessly receiving data. It is noteworthy that, although transceiver 1016 and transceiver 1026 are illustrated as being external to and separate from processor 1012 and processor 1022, respectively, in some implementations, transceiver 1016 may be an integral part of processor 1012 as a system on chip (SoC), and transceiver 1026 may be an integral part of processor 1022 as a SoC.

In some implementations, apparatus 1010 may further include a memory 1014 coupled to processor 1012 and capable of being accessed by processor 1012 and storing data therein. In some implementations, apparatus 1020 may further include a memory 1024 coupled to processor 1022 and capable of being accessed by processor 1022 and storing data therein. Each of memory 1014 and memory 1024 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 1014 and memory 1024 may include a type of read-only memory (ROM) such as mask ROM, programmable ROM (PROM), erasable programmable ROM (EPROM) and/or electrically erasable programmable ROM (EEPROM). Alternatively, or additionally, each of memory 1014 and memory 1024 may include a type of non-volatile random-access memory (NVRAM) such as flash memory, solid-state memory, ferroelectric RAM (FeRAM), magnetoresistive RAM (MRAM) and/or phase-change memory.

Each of apparatus 1010 and apparatus 1020 may be a communication entity capable of communicating with each other using various proposed schemes in accordance with the present disclosure. For illustrative purposes and without limitation, a description of capabilities of apparatus 1010, as STA 110, and apparatus 1020, as STA 120, is provided below in the context of example process 1100. It is noteworthy that, although a detailed description of capabilities, functionalities and/or technical features of either of apparatus 1010 and apparatus 1020 is provided below, the same may be applied to the other of apparatus 1010 and apparatus 1020 although a detailed description thereof is not provided solely in the interest of brevity. It is also noteworthy that, although the example implementations described below are provided in the context of WLAN, the same may be implemented in other types of networks.

### Illustrative Processes

FIG. 11 illustrates an example process 1100 in accordance with an implementation of the present disclosure. Process 1100 may represent an aspect of implementing various proposed designs, concepts, schemes, systems and methods described above. More specifically, process 1100 may represent an aspect of the proposed concepts and schemes pertaining to transmission methods for hybrid power modes in 6 GHz frequency band in wireless communications in accordance with the present disclosure. Process 1100 may include one or more operations, actions, or functions as illustrated by one or more of blocks 1110 and 1120. Although illustrated as discrete blocks, various blocks of process 1100 may be divided into additional blocks, combined into fewer blocks, or eliminated, depending on the desired implementation. Moreover, the blocks/sub-blocks of process 1100 may be executed in the order shown in FIG. 11 or, alternatively, in a different order. Furthermore, one or more of the blocks/sub-blocks of process 1100 may be executed repeatedly or iteratively. Process 1100 may be implemented by or in apparatus 1010 and apparatus 1020 as well as any variations thereof. Solely for illustrative purposes and without limiting the scope, process 1100 is described below in the context of apparatus 1010 implemented in or as STA 110 functioning as a non-AP STA and apparatus 1020 implemented in or as STA 120 functioning as an AP STA of a wireless network such as a WLAN in network environment 100 in accordance with one or more of IEEE 802.11 standards. Process 1100 may begin at block 1110.

At 1110, process 1100 may involve processor 1012 of apparatus 1010 generating one or more RUs. Process 1100 may proceed from 1110 to 1120.

At 1120, process 1100 may involve processor 1012 communicating, via transceiver 1016, wirelessly (e.g., with apparatus 1020) using the one or more RUs with a hybrid of power modes.

In some implementations, in communicating, process 1100 may involve processor 1012 performing certain operations. For instance, process 1100 may involve processor 1012 transmitting in an SP mode in a first portion of a transmission bandwidth. Additionally, process 1100 may involve processor 1012 transmitting in an LPI mode in a second portion of the transmission bandwidth.

In some implementations, the one or more RUs may include at least a first RU. Moreover, in communicating, process 1100 may involve processor 1012 performing certain operations. For instance, process 1100 may involve processor 1012 transmitting a first portion of the first RU in an SP mode in a first portion of a transmission bandwidth. Furthermore, process 1100 may involve processor 1012 transmitting a second portion of the first RU in an LPI mode in a second portion of the transmission bandwidth.

In some implementations, the one or more RUs may include a first RU of a first type and a second RU of a second type different than the first type. Moreover, in communicating, process 1100 may involve processor 1012 performing certain operations. For instance, process 1100 may involve processor 1012 transmitting the first RU in an SP mode in a first portion of a transmission bandwidth. Furthermore, process 1100 may involve processor 1012 transmitting the second RU in an LPI mode in a second portion of the transmission bandwidth. In some implementations, the first RU may include an RRU, and the second RU may include a DRU.

In some implementations, in communicating, process 1100 may involve processor 1012 communicating with a bitmap indicating a respective RU type of each 80 MHz frequency segment or subblock of a transmission bandwidth.

In some implementations, in communicating, process 1100 may involve processor 1012 performing certain operations. For instance, process 1100 may involve processor 1012 transmitting with a higher QAM or MCS in a first portion of a transmission bandwidth. Moreover, process 1100 may involve processor 1012 transmitting with a lower QAM or MCS in a second portion of the transmission bandwidth. In some implementations, in communicating, process 1100 may further involve processor 1012 transmitting in the SP mode in the first portion of the transmission bandwidth and transmitting in the LPI mode in the second portion of the transmission bandwidth. Alternatively, in case that the one or more RUs includes at least a first RU, in communicating, process 1100 may further involve processor 1012 transmitting a first portion of the first RU in the SP mode in the first portion of the transmission bandwidth and transmitting a second portion of the first RU in the LPI mode in the second portion of the transmission bandwidth. Still alternatively, in case that the one or more RUs include a first RU of a first type and a second RU of a second type different than the first type, in communicating, process 1100 may further involve processor 1012 transmitting the first RU in the SP mode in the first portion of the transmission bandwidth and transmitting the second RU in the LPI mode in the second portion of the transmission bandwidth.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
generating, by a processor of an apparatus, one or more resource unit (RUs); and
communicating, by the processor, wirelessly using the one or more RUs with a hybrid of power modes.

2. The method of claim 1, wherein the communicating comprises:
transmitting in a standard power (SP) mode in a first portion of a transmission bandwidth; and
transmitting in a lower power indoor (LPI) mode in a second portion of the transmission bandwidth.

3. The method of claim 1, wherein the one or more RUs comprises at least a first RU, and wherein the communicating comprises:
transmitting a first portion of the first RU in a standard power (SP) mode in a first portion of a transmission bandwidth; and
transmitting a second portion of the first RU in a lower power indoor (LPI) mode in a second portion of the transmission bandwidth.

4. The method of claim 1, wherein the one or more RUs comprises a first RU of a first type and a second RU of a second type different than the first type, and wherein the communicating comprises:
transmitting the first RU in a standard power (SP) mode in a first portion of a transmission bandwidth; and
transmitting the second RU in a lower power indoor (LPI) mode in a second portion of the transmission bandwidth.

5. The method of claim 4, wherein the first RU comprises a regular RU (RRU), and wherein the second RU comprises a distributed-tone RU (DRU).

6. The method of claim 1, wherein the communicating comprises communicating with a bitmap indicating a respective RU type of each 80 MHz frequency segment or subblock of a transmission bandwidth.

7. The method of claim 1, wherein the communicating comprises:
transmitting with a higher quadrature amplitude modulation (QAM) or modulation and coding scheme (MCS) in a first portion of a transmission bandwidth; and
transmitting with a lower QAM or MCS in a second portion of the transmission bandwidth.

8. The method of claim 7, wherein the communicating further comprises:
transmitting in a standard power (SP) mode in the first portion of the transmission bandwidth; and
transmitting in a lower power indoor (LPI) mode in the second portion of the transmission bandwidth.

9. The method of claim 7, wherein the one or more RUs comprises at least a first RU, and wherein the communicating further comprises:
transmitting a first portion of the first RU in a standard power (SP) mode in the first portion of the transmission bandwidth; and
transmitting a second portion of the first RU in a lower power indoor (LPI) mode in the second portion of the transmission bandwidth.

10. The method of claim 7, wherein the one or more RUs comprises a first RU of a first type and a second RU of a second type different than the first type, and wherein the communicating further comprises:
transmitting the first RU in a standard power (SP) mode in the first portion of the transmission bandwidth; and
transmitting the second RU in a lower power indoor (LPI) mode in the second portion of the transmission bandwidth.

11. An apparatus, comprising:
a transceiver configured to communicate wirelessly; and
a processor coupled to the transceiver and configured to perform operations comprising:
generating one or more resource unit (RUs); and
communicating, via the transceiver, wirelessly using the one or more RUs with a hybrid of power modes.

12. The apparatus of claim 11, wherein the communicating comprises:
transmitting in a standard power (SP) mode in a first portion of a transmission bandwidth; and
transmitting in a lower power indoor (LPI) mode in a second portion of the transmission bandwidth.

13. The apparatus of claim 11, wherein the one or more RUs comprises at least a first RU, and wherein the communicating comprises:
transmitting a first portion of the first RU in a standard power (SP) mode in a first portion of a transmission bandwidth; and
transmitting a second portion of the first RU in a lower power indoor (LPI) mode in a second portion of the transmission bandwidth.

14. The apparatus of claim 11, wherein the one or more RUs comprises a first RU of a first type and a second RU of a second type different than the first type, and wherein the communicating comprises:
transmitting the first RU in a standard power (SP) mode in a first portion of a transmission bandwidth; and
transmitting the second RU in a lower power indoor (LPI) mode in a second portion of the transmission bandwidth.

15. The apparatus of claim 14, wherein the first RU comprises a regular RU (RRU), and wherein the second RU comprises a distributed-tone RU (DRU).

16. The apparatus of claim 11, wherein the communicating comprises communicating with a bitmap indicating a respective RU type of each 80 MHz frequency segment or subblock of a transmission bandwidth.

17. The apparatus of claim 11, wherein the communicating comprises:
transmitting with a higher quadrature amplitude modulation (QAM) or modulation and coding scheme (MCS) in a first portion of a transmission bandwidth; and
transmitting with a lower QAM or MCS in a second portion of the transmission bandwidth.

18. The apparatus of claim 17, wherein the communicating further comprises:
transmitting in a standard power (SP) mode in the first portion of the transmission bandwidth; and
transmitting in a lower power indoor (LPI) mode in the second portion of the transmission bandwidth.

19. The apparatus of claim 17, wherein the one or more RUs comprises at least a first RU, and wherein the communicating further comprises:
transmitting a first portion of the first RU in a standard power (SP) mode in the first portion of the transmission bandwidth; and
transmitting a second portion of the first RU in a lower power indoor (LPI) mode in the second portion of the transmission bandwidth.

20. The apparatus of claim 17, wherein the one or more RUs comprises a first RU of a first type and a second RU of a second type different than the first type, and wherein the communicating further comprises:
transmitting the first RU in a standard power (SP) mode in the first portion of the transmission bandwidth; and
transmitting the second RU in a lower power indoor (LPI) mode in the second portion of the transmission bandwidth.
